(19) United States
(12) Patent Application Publication
(10) Pub. No.: US 2015/0362587 A1
(43) Pub. Date: Dec. 17, 2015

(54) LIDAR SENSOR CALIBRATION USING SURFACE PATTERN DETECTION

(71) Applicant: Microsoft Corporation, Redmond, WA (US)

(72) Inventors: Aaron Matthew Rogan, Westminster, CO (US); Benjamin James Kadlec, Boulder, CA (US); Michael Riley Harrell, Denver, CO (US)

(21) Appl. No.: 14/306,755

(22) Filed: Jun. 17, 2014

(51) Int. Cl. G01S 7/497; G01S 17/89

(52) U.S. Cl. CPC G01S 7/497; G01S 17/89

(57) ABSTRACT

Lidar scanning is used in a variety of scenarios to detect the locations, sizes, shapes, and/or orientations of a variety of objects. The accuracy of such scanning techniques is dependent upon the calibration of the orientation of the lidar sensor, because small discrepancies between a presumed orientation and an actual orientation may result in significant differences in the detected properties of various objects. Such errors are often avoided by calibrating the lidar sensor before use for scanning, and/or registering the lidar data set, but lidar sensors in the field may still become miscalibrated and may generate inaccurate data. Presented herein are techniques for identifying, verifying, and/or correcting for lidar calibration by projecting a lidar pattern on a surface of the environment, and detecting changes in detected geometry from one or more locations. Comparing detected angles with predicted angles according to a predicted calibration enables the detection of calibration differences.

### BACKGROUND

Within the field of computing, many scenarios involve the use of light detection and ranging, or lidar, to map objects in an environment. In a first such scenario, an area mapping vehicle may include a lidar device that travels through an area and utilizes a lidar device to map the positions, sizes, shapes, and orientations of objects such as buildings and street surfaces. In a second such scenario, a lidar device mounted to a vehicle may detect the locations, orientations, and velocities of other vehicles, which may inform the control of the vehicle by human and/or automated processes. In a third such scenario, an object scanner may use a lidar device to detect the size, shape, orientation, and surface details of a three-dimensional object positioned within a scanning chamber.

In these and other such scenarios, calibration of the orientation of the lidar device significantly affects the achievable accuracy and/or precision of the lidar-based scanning. Even small errors in orientation calibration, such as a small difference between a presumed orientation and an actual orientation, may result in a variety of errors. For example, a slightly heading rotation, a slight forward pitch, and/or a slight roll as compared with a presumed orientation may result in significant inaccuracies in the detected locations, orientations, sizes, shapes, surface details, and/or velocities of the scanned objects.

In view of such difficulties, a variety of calibration techniques are utilized to prepare a lidar scanner before use, particularly those to be utilized in a vehicle that is in motion and potentially subjected to a variety of physical forces. As a first example, the lidar detector may be rigidly fixed in a highly precise set of brackets that affix the orientation of the lidar detectors in the presumed orientation. As a second example, prior to deployment in an environment, a lidar sensor may be subjected to test patterns in order to match detected objects with predicted objects when scanned according to an accurately oriented lidar sensor. As a third example, a data set generated by a lidar sensor may be subjected to registration techniques that detect and correct minor orientation errors. Such calibration techniques may therefore be utilized before and/or after deployment of the lidar sensor for a desired scanning context in order to detect and/or correct for differences in the orientation of the lidar sensor.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In some scenarios, the orientation of a lidar sensor may be determined based on observations of the geometry observed by the lidar sensor as the lidar sensor moves through an environment. For example, a surface may be detected by which the lidar sensor may detect the range between the surface and the lidar sensor. As the lidar sensor moves through the environment, continued detection of the range of the surface at different locations of the lidar sensor along a particular dimension (e.g., a horizontal axis) may enable a determination of the orientation of the lidar sensor with respect to dimension.

Presented herein are techniques for calibrating and/or verifying an orientation of a lidar sensor. In accordance with these techniques, while the lidar sensor is positioned at a location that is near a surface and has a predicted orientation, an embodiment may project a lidar pattern on the surface from the location, and, upon detecting the lidar pattern with the lidar sensor, determine a detected angle of the lidar pattern. The embodiment may also determine a predicted angle of the lidar sensor at the location with the predicted orientation, and compare the detected angle of the lidar pattern with the predicted angle to determine an orientation difference. Such determinations may enable verification of a presumed orientation of the lidar sensor; detection of an orientation difference between the presumed orientation and the detection orientation; correction of the detected orientation difference; and/or registration of data captured by the lidar sensor in view of the orientation difference, in accordance with the techniques presented here.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a detection of objects in an environment using a lidar sensor.

FIG. 2 is an illustration of an exemplary scenario featuring errors that may arise in the detection of objects in an environment due to discrepancies in a predicted orientation of a lidar sensor.

FIG. 3 is an illustration of an exemplary scenario featuring a detection of an orientation difference of a lidar sensor through the projection and detection of a lidar pattern on a surface in accordance with the techniques presented herein.

FIG. 4 is an illustration of an exemplary scenario featuring the detection of an orientation difference between a predicted orientation and a determined orientation of a lidar sensor in accordance with the techniques presented herein.

FIG. 5 is an illustration of a first exemplary method of verifying an orientation of a lidar sensor in accordance with the techniques presented herein.

FIG. 6 is a component block diagram illustrating an exemplary device featuring a calibration of a lidar sensor in accordance with the techniques presented herein.

FIG. 7 is an illustration of an exemplary computer-readable medium including processor-executable instructions configured to embody one or more of the provisions set forth herein.

FIG. 8 is an illustration of an exemplary scenario featuring a three-dimensional calibration of an orientation of a lidar sensor through the detection of two orthogonal surfaces in accordance with the techniques presented herein.

FIG. 9 is an illustration of an exemplary scenario featuring a three-dimensional calibration of an orientation of a lidar sensor through the projection and detection of a two-dimensional lidar pattern on a two-dimensional orthogonal surfaces in accordance with the techniques presented herein.

FIG. 10 is an illustration of an exemplary computing environment wherein a portion of the present techniques may be implemented and/or utilized.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

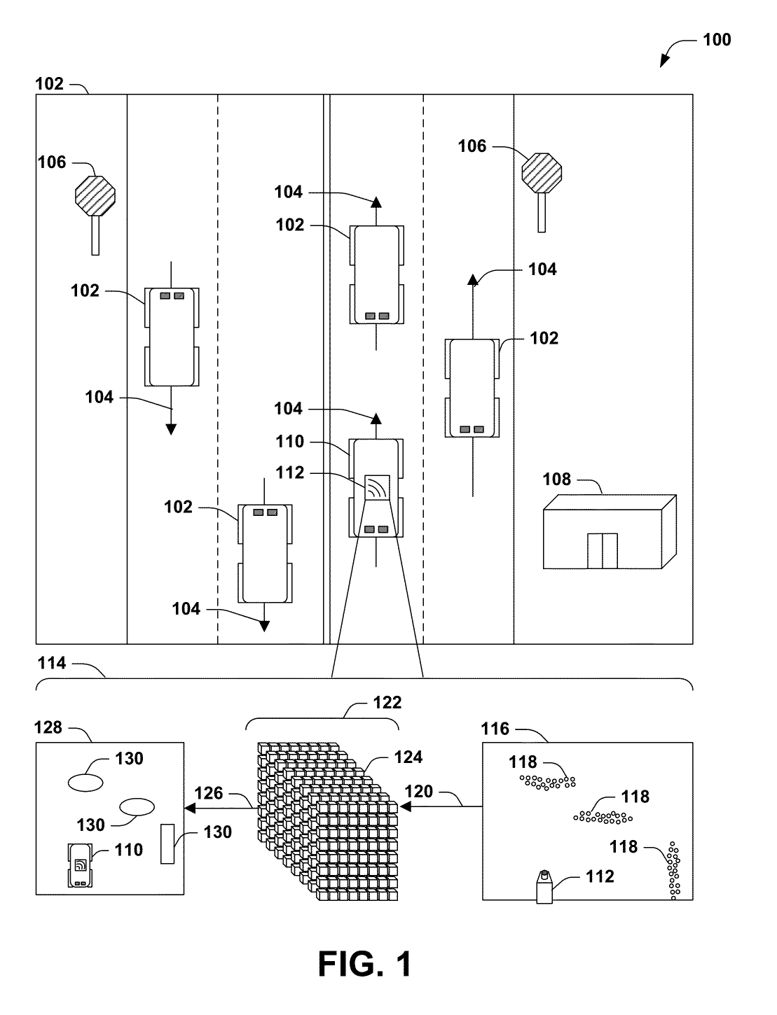

FIG. 1 is an illustration of an exemplary scenario 100 featuring an exemplary scenario involving a scanning of an environment 102 using a lidar sensor 112. In this exemplary scenario 100, a vehicle 110 with an onboard lidar sensor 112 travels through the environment 102 concurrently with other vehicles 102, each having a velocity 104 with respect to the environment 102. Also present within the environment 102 are stationary objects, such as road signs 106 and buildings 108.

While traveling through the environment 102, the vehicle 110 may utilize the lidar sensor 112 to scan 114 some or all of these objects using light-based ranging and detection, in the following manner. The lidar 112 may rotate with respect to the vehicle 110 while projecting pulses of light in various directions, while also detecting the reflection of such pulses of light. The duration between the projection and detection for each pulse, coupled with the orientation of the lidar sensor 112 during the projection, enables a determination of the range between the lidar sensor 112 and a reflective object in the direction of the orientation. By performing such detection at a high resolution and rate in particular radius, the lidar detector 112 may generate a map 116 of the respective points relative to the location of the lidar sensor 110. Techniques such as clustering may enable the identification of point clouds 118 for the respective objects in the environment 102. A registration 120 of the respective points with a coordinate space 122 enables the determination of volumetric pixels, or voxels 124, within an objective or stationary frame of reference with respect to the environment 102. Such registration also enables a mapping 126 of objects 130 within an object map 128 with respect to the location of the vehicle 110 in near-realtime. In this manner, lidar mapping may be utilized to detect the locations, sizes, shapes, orientations, and/or velocities of objects in the environment 102, such as other vehicles and the surfaces of buildings.

However, in such scenarios, the accuracy of lidar mapping is significantly dependent upon the calibration of the orientation of the lidar sensor 112. That is, determining the range of a particular voxel 124 only involves detecting the duration between the projection of the light pulse and the detection of its reflection, but determining the direction of the voxel 124 within three-dimensional space depends significantly upon precise knowledge of the orientation of the lidar sensor 112 during projection and/or detection. A miscalibration of the lidar sensor 112 along any axis or dimension with respect to a presumed orientation—e.g., exhibiting a pitch forward or backward; exhibiting a longitudinal roll; or exhibiting a planar rotation of heading—results in inaccuracies in the registration of voxels 124 within the coordinate space 124.

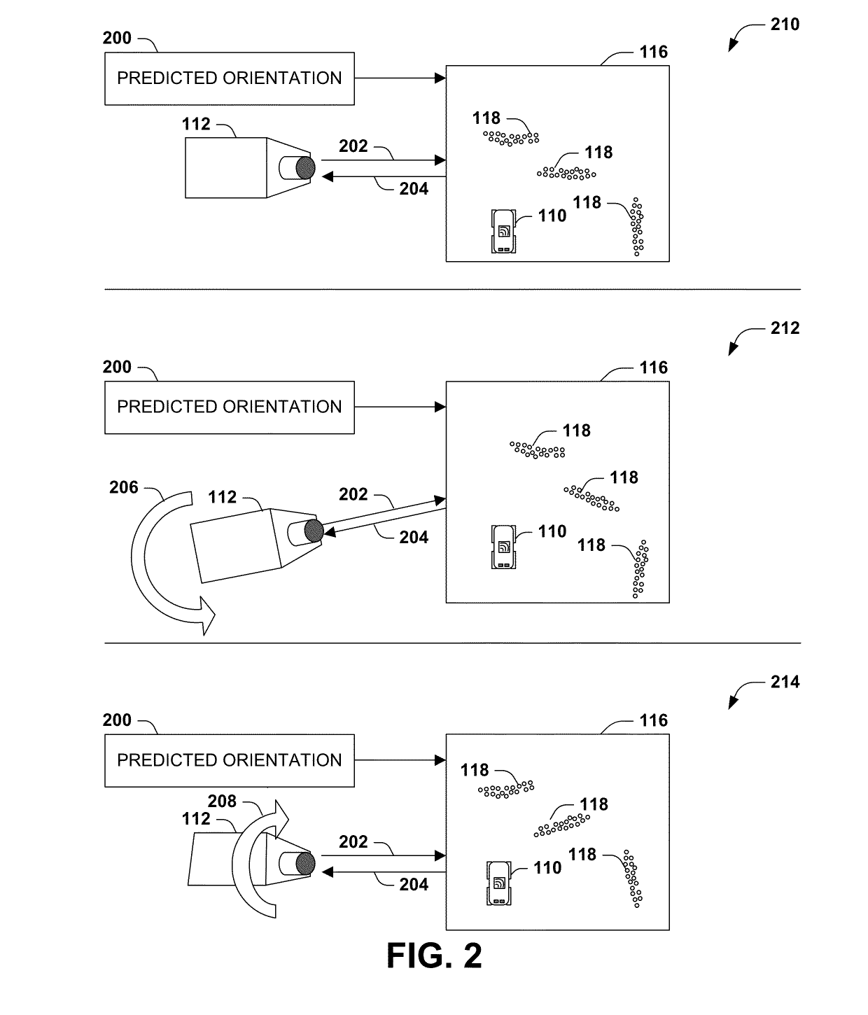

FIG. 2 is an illustration of exemplary scenarios featuring a few sources of inaccuracy due to miscalibration of the orientation of the lidar sensor 112. In a first exemplary scenario 210, the lidar sensor 112 is presumed to have a predicted orientation 200 while projecting 202 light toward the objects of the environment 102, and while detecting 204 reflected light from the objects. The predicted orientation 200, coupled with the measured delay between projection and detection, enables the determination of point clouds 118 within the map 116 of the vicinity of the lidar sensor 112. In a second exemplary scenario 212, the lidar sensor 112 exhibits an incorrect heading rotation 206 or yaw with respect to a predicted orientation 200 (e.g., when expected to be oriented directly forward, the lidar sensor 112 is instead oriented at a slight angle). As a result, the point clouds 118 in the map 116 may exhibit a rotation in the three-dimensional coordinate space 112 with respect to the location of the vehicle 110 and/or the lidar sensor 112. In a third exemplary scenario 214, the lidar sensor 112 exhibits a roll miscalibration 208, such as a longitudinal rotation of the lidar sensor 112 with respect to the predicted orientation 200. While the duration between projecting 202 and detecting 204 is not affected by the roll rotation 206, the registration 120 of the points within a three-dimensional coordinate space 122 is altered as the lidar sensor 112 rotates around various axes. The resulting map 116 may exhibit point clouds 118 with an inaccurate angular rotation with respect to the lidar sensor 112; e.g., as the lidar sensor 112 rotates along an out-of-horizontal plane while performing lidar ranging, the detected objects may exhibit a slanted orientation with respect to the horizontal plane.

In order to address such inaccuracies, a variety of techniques may be utilized to establish and/or correct for the orientation calibration of the lidar sensor 112. As a first example, the lidar sensor 112 may be mounted within the vehicle 110 in a rigid bracket that affixes the orientation of the lidar sensor 112 in the predicted orientation 200. As a second example, the orientation of the lidar sensor 112 may be carefully tested and tuned prior to deployment in an environment 102 for lidar-based scanning, e.g., by carefully measuring and verifying the predicted orientation 200 in a controlled setting. However, the lidar sensor 112 may nevertheless exhibit a miscalibration after testing and during deployment in the environment 102, e.g., due to physical forces exerted on the lidar sensor 112 while traveling in the vehicle 110. As a third example, the data captured by the lidar sensor 112 may be evaluated after lidar scanning to verify the accurate calibration of the lidar sensor 112 during scanning. In some scenarios, a miscalibration may be corrected by applying an adjustment to the voxels 124 of the three-dimensional coordinate system 122. However, such corrective techniques may exhibit a loss of accuracy and/or precision with respect to accurately captured lidar data. Additionally, such registration techniques may be computationally intensive, and/or may be unsuitable for scenarios where lidar ranging is utilized in near-realtime, such as lidar-assisted vehicle navigation. Accordingly, techniques that may be utilized to evaluate the orientation calibration of the lidar sensor 112 during deployment in the environment 102 may be desirable for a variety of scenarios.

### B. Presented Techniques

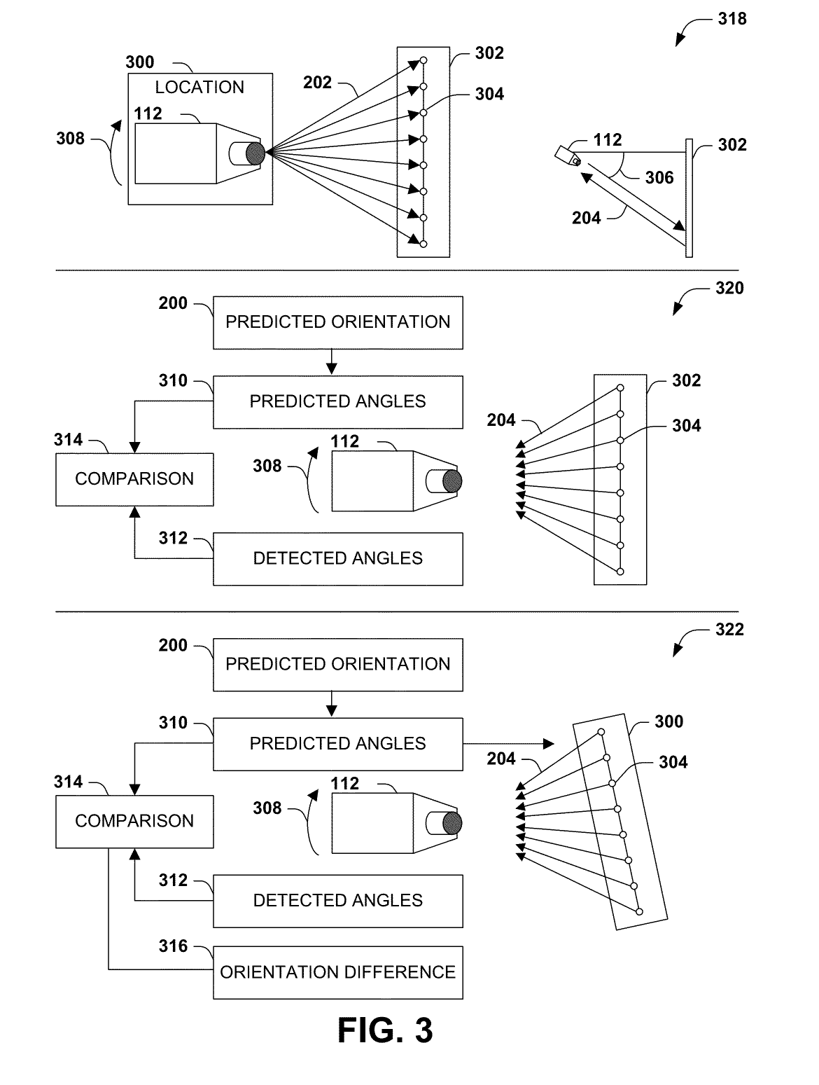

FIG. 3 is an illustration of an application of the techniques presented herein for detecting an orientation difference of a lidar sensor 112 with respect to a predicted orientation 200. In accordance with the techniques presented herein, a lidar sensor 112 may detect a surface 302 near the location 300 of the lidar sensor 112, and may project 202 a lidar pattern 304 on the surface 302. An evaluation of the geometry of the detection of the lidar pattern 304 may enable a comparison with a predicted orientation 200 wherein the lidar sensor 112 is orthogonal with the surface 302.

In a first exemplary scenario 318, the lidar sensor 112 rotates 308 along an axis with respect to the surface 302 while projecting 202 a sequence of light pulses, and may detect 204 the duration of the projecting 202 and detecting 202 in order to detect the range of each pulse between the location 300 of the lidar sensor 112 and the surface 302. An evaluation of the respective lidar points of the lidar pattern 304 may indicate a detected angle 306 between the lidar sensor 112 and the surface 302. For example, such calculation may utilize the distance between the location 300 and the surface 302, and, as a hypotenuse, the distance of the projection of the lidar pattern 302 according to the duration of projection and detection 204 as measured by the lidar sensor 112. The cosine of these distances reveals the angle 306 of projection of the lidar pattern 112 with respect to the location 300 of the lidar sensor 112 and the surface 302.

In a second exemplary scenario 320, where the surface 302 is orthogonal to the lidar sensor 112, the lidar sensor 112 exhibits a detection of the lidar pattern 304 that is consistent with the predicted orientation 200; e.g., the detected angles 312 of the respective points of the lidar pattern 304 match the predicted angles 310 according to the location 300 of the lidar sensor 112, the location of the surface 302, and an orthogonal orientation of the surface 302 with respect to the lidar sensor 112. As one example, as the lidar sensor 112 rotates 308 through a radial arc, the detected duration of the lidar pattern 304 exhibit a linear symmetry. However, in a third exemplary scenario 322, the surface 302 is not oriented orthogonally with the lidar sensor 112, and is therefore inconsistent with the predicted orientation 200. Accordingly, when the lidar sensor 112 rotates 308 through a radial arc, the detected angles 312 of the respective points of the lidar pattern 304 do not match the predicted angles 310. As one example, the detected points are no longer symmetric with respect to the midpoint of the lidar pattern 304. A comparison 314 therefore reveals an orientation difference 316 of the lidar sensor 112 with respect to the surface 302 along the axis or dimension along which the surface 302 is predicted to be orthogonal to the lidar sensor 112.

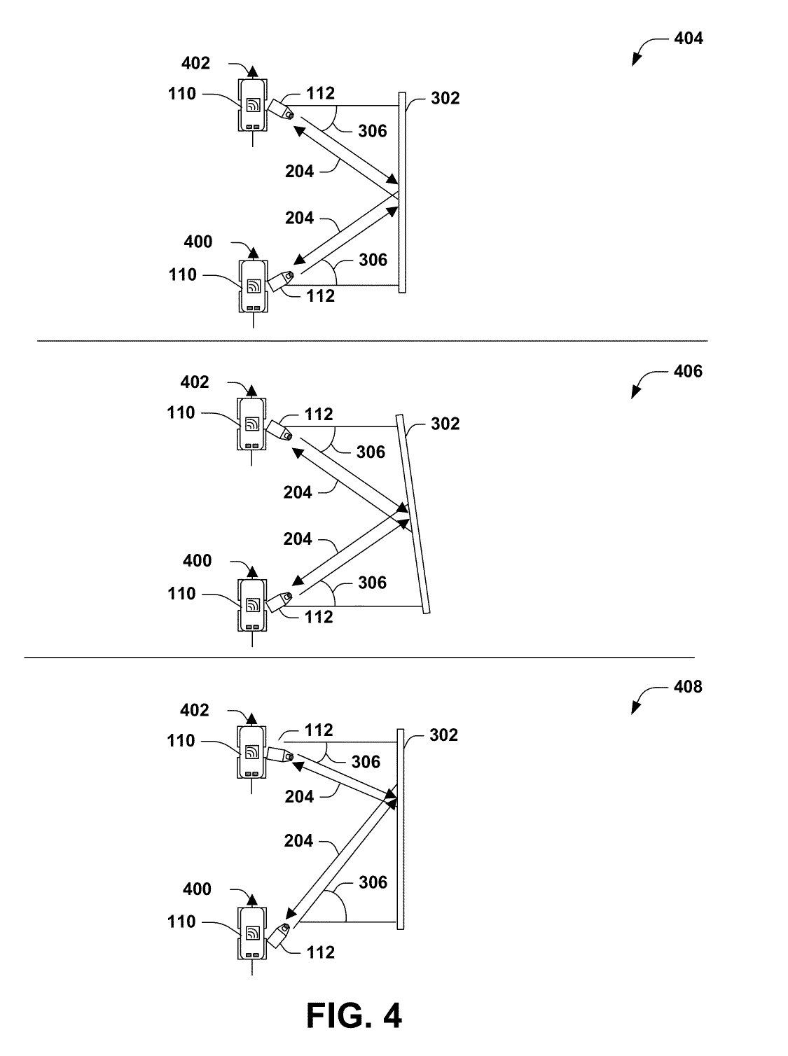

FIG. 4 is an illustration of a further application of the techniques presented herein, involving the further evaluation of a projection of a lidar pattern 304 on a surface 302. In the exemplary scenarios of FIG. 4, the lidar sensor 112 evaluates the projection of the lidar pattern 304 on an approximately equivalent position of the surface 302 from both a first location 400 and a second location 402 of a vehicle 110 traveling in the proximity of the surface 302. Comparison of the detected lidar pattern 304 detected from the respective locations 300 reveals a different type of effect in each exemplary scenario. In a first exemplary scenario 404, the lidar sensor 112 is oriented in accordance with a predicted orientation 200, and is orthogonal to the surface 302. Accordingly, when the lidar pattern 304 is projected on a particular position of the surface 302 from the first location 400 and a second location 402, the lidar sensor 112 detects approximately equivalent angles 306. In a second exemplary scenario 406, even if the surface 302 is oriented at an angle with respect to the lidar sensor 112 and the vehicle 110, a projection of the lidar pattern 112 at a particular position on the surface 302 may result in the detection of approximately equivalent angles 306 from the first location 400 and the second location 402. However, in a third exemplary scenario 408, the lidar sensor 112 exhibits a rotational miscalibration, such that the projection of the lidar pattern 304 on the surface 302 from the first location 400 results in a significantly longer hypotenuse, while the projection of the lidar pattern 304 on the surface 302 from the second location 402 results in a significantly shorter hypotenuse. This discrepancy reflects a deviation of the detected angles 312 from the predicted angles 310 according to the predicted orientation 200. In this manner, the comparison of the predicted angles 310 of the lidar pattern 304 projected on the surface 302 from the locations 300 as the lidar sensor 112 is transported by the vehicle 110 reveals the rotational miscalibration of the lidar sensor 112 in accordance with the techniques presented herein.

### C. Technical Effects

The evaluation of the orientation of a lidar sensor 112 in accordance with the techniques presented herein, such as illustrated in the exemplary scenarios of FIGS. 3 and 4, may present a variety of technical effects as compared with other techniques.

As a first example, the calibration techniques provided herein may enable an evaluation of the orientation calibration of the lidar sensor 112 during use, e.g., while aboard a vehicle 110 traveling through an environment 102. Such calibration techniques may therefore be more convenient or readily applicable than calibration techniques involving an evaluation in a controlled setting prior to deployment. Alternatively, such techniques may supplement a controlled pre-deployment calibration, e.g., by continuously verifying the predicted orientation 200 established before deployment of the lidar sensor 112 in the environment 102, and/or a detection of an orientation miscalibration arising in the environment 102, such as due to physical forces imposed on the lidar sensor 112 while aboard the vehicle 110.

As a second example, the calibration techniques provided herein may enable the orientation calibration of the lidar sensor 112 without the involvement of calibration hardware, such as a specialized testing environment or rigid calibration mount. Rather, the techniques provided herein may utilize any surface 302 detected in the proximity of the lidar sensor 112. Such techniques may therefore reduce the costs and/or complexity of orientation calibration, and may be utilized by the provision of a software algorithm for the lidar sensor 112.

As a third example, the calibration techniques provided herein may enable a detection of a miscalibration during use, e.g., in near-realtime. Such techniques may therefore enable a detection of miscalibration during use (e.g., reducing the collection of unusable miscalibrated lidar data) and/or a correction of miscalibration during use (e.g., enabling a recalibration of the lidar sensor 112 by a user, such that the collected lidar data is accurate and does not have to be adjusted during post-collection registration).

As a fourth example, the near-realtime utilization of the calibration techniques provided herein may enable application in scenarios where post-collection orientation verification is not suitable, such as lidar-assisted vehicle navigation. These and other technical effects may be achievable through the use of the lidar sensor calibration techniques presented herein.

### D. Exemplary Embodiments

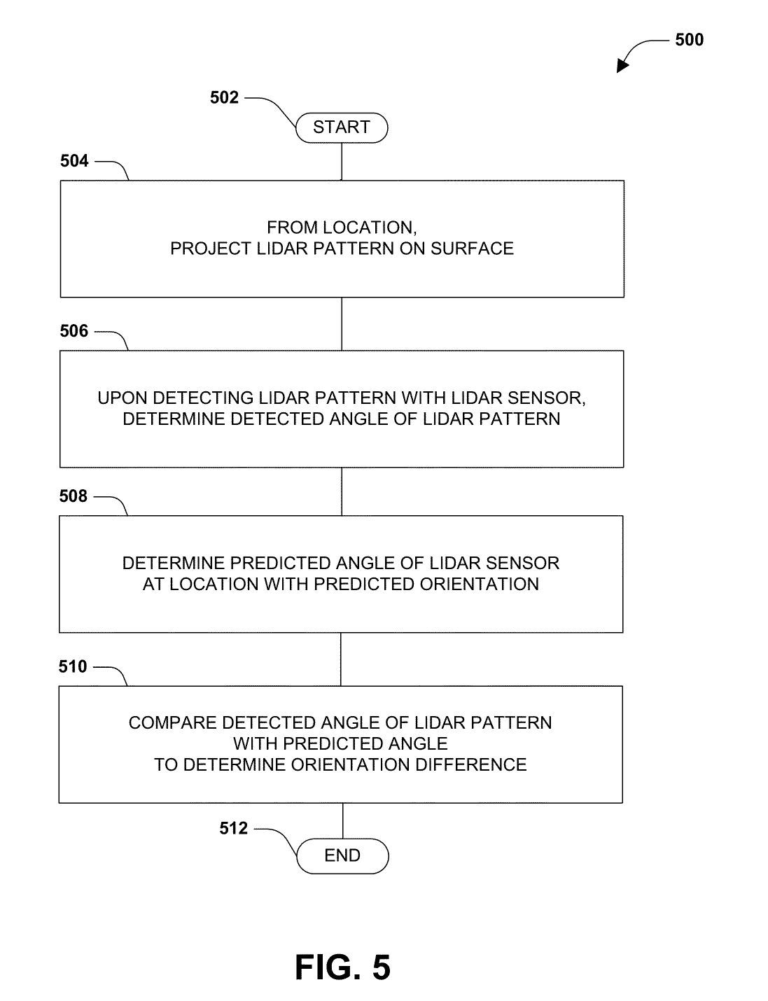

FIG. 5 presents an illustration of a first embodiment of the techniques presented herein, illustrated as an exemplary method 500 of verifying a predicted orientation 200 of a lidar sensor 112 positioned at a location 300 near a surface 302. The exemplary method 500 may be implemented, e.g., as a set of instructions stored in a memory component (e.g., a memory circuit, a platter of a hard disk drive, a solid-state storage device, or a magnetic or optical disc) of a device having a processor, where the instructions, when executed on the processor, cause the device to operate according to the techniques presented herein. The exemplary method 500 begins at 502 and involves, from the location 300, projecting 504 a lidar pattern 304 on the surface 302. The exemplary method 500 also involves, upon detecting 204 the lidar pattern 304 with the lidar sensor 112, determining 506 a detected angle 306 of the lidar pattern 304. The exemplary method 500 also involves determining 508 a predicted angle 310 of the lidar sensor 112 at the location 300 with the predicted orientation 200. The exemplary method 500 also involves comparing 510 the detected angle 306 of the lidar pattern 304 with the predicted angle 310 to determine an orientation difference 316. In this manner, the exemplary method 500 enables a detection of an orientation difference 316 between the predicted orientation 200 of the lidar sensor 112 and the detected angle 306 of the lidar pattern 304 projected on the surface 302, and so ends at 512.

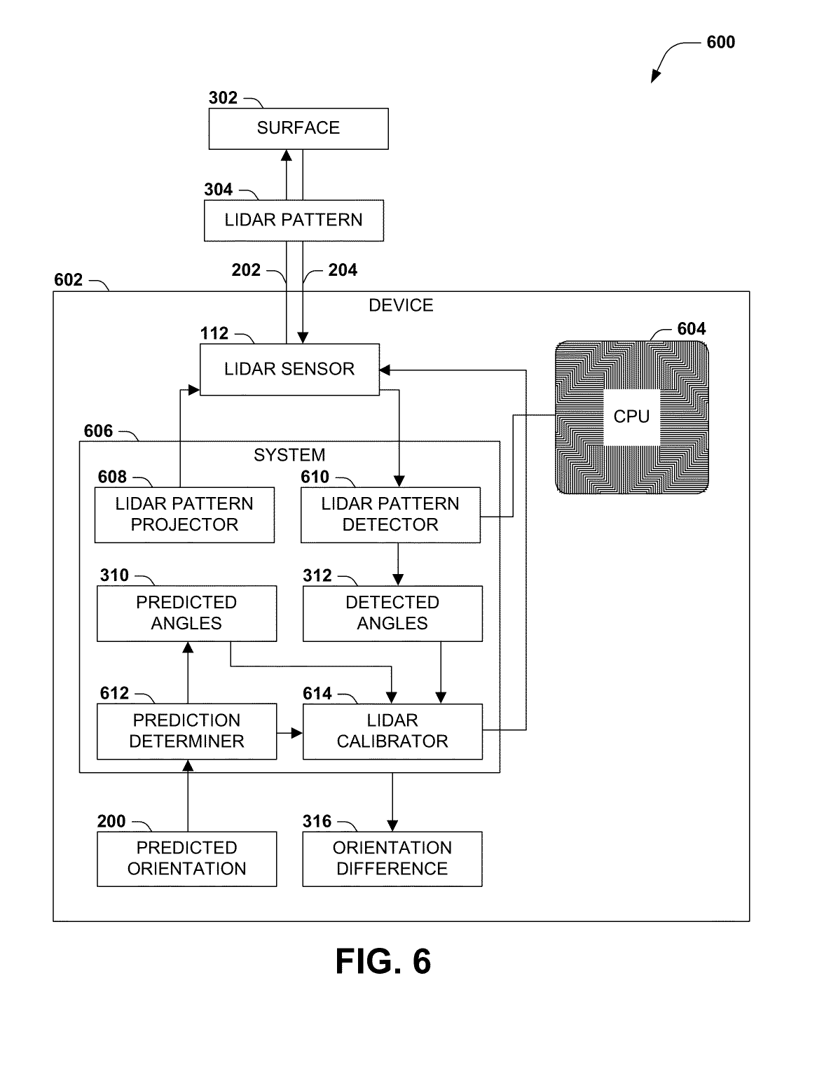

FIG. 6 presents an illustration of a second embodiment of the techniques presented herein, illustrated as an exemplary device 602 upon which is implemented an exemplary system 606 for calibrating a lidar sensor 112 of the device 602 that has a predicted orientation 200. The respective components of the exemplary system 606 may be implemented, e.g., as instructions stored in a memory component of the exemplary device 602 that, when executed on a processor 604 of the exemplary device 602, cause the exemplary device 602 to perform at least a portion of the techniques presented herein. Alternatively (though not shown), one or more components of the exemplary system 606 may be implemented, e.g., as a volatile or nonvolatile logical circuit, such as a particularly designed semiconductor-on-a-chip (SoC) or a configuration of a field-programmable gate array (FPGA), that performs at least a portion of the techniques presented herein, such that the interoperation of the components completes the performance of a variant of the techniques presented herein.

The exemplary system 606 includes a lidar pattern projector 608 that, from the location 300, projects a lidar pattern 304 on the surface 302. The exemplary system 606 also includes a lidar pattern detector 610 that detects the lidar pattern 304 with the lidar sensor 112, and determines a detected angle 306 of the lidar pattern 304. The exemplary system 606 also includes a prediction determiner 612 that, according to the predicted orientation 200, determines a predicted angle 310 of the lidar sensor 112 at the location 300. The exemplary system 606 also includes a lidar calibrator 614 that compares the detected angle 312 of the lidar pattern 304 with the predicted angle 310 to determine an orientation difference 316, and calibrates the lidar sensor 112 according to the orientation difference 316. In this manner, the architecture and interoperation of the components of the exemplary system 606 of FIG. 6 enable the exemplary device 602 to calibrate the lidar sensor 112 in accordance with the techniques presented herein.

Still another embodiment involves a computer-readable medium comprising processor-executable instructions configured to apply the techniques presented herein. Such computer-readable media may include, e.g., computer-readable storage devices involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage devices) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

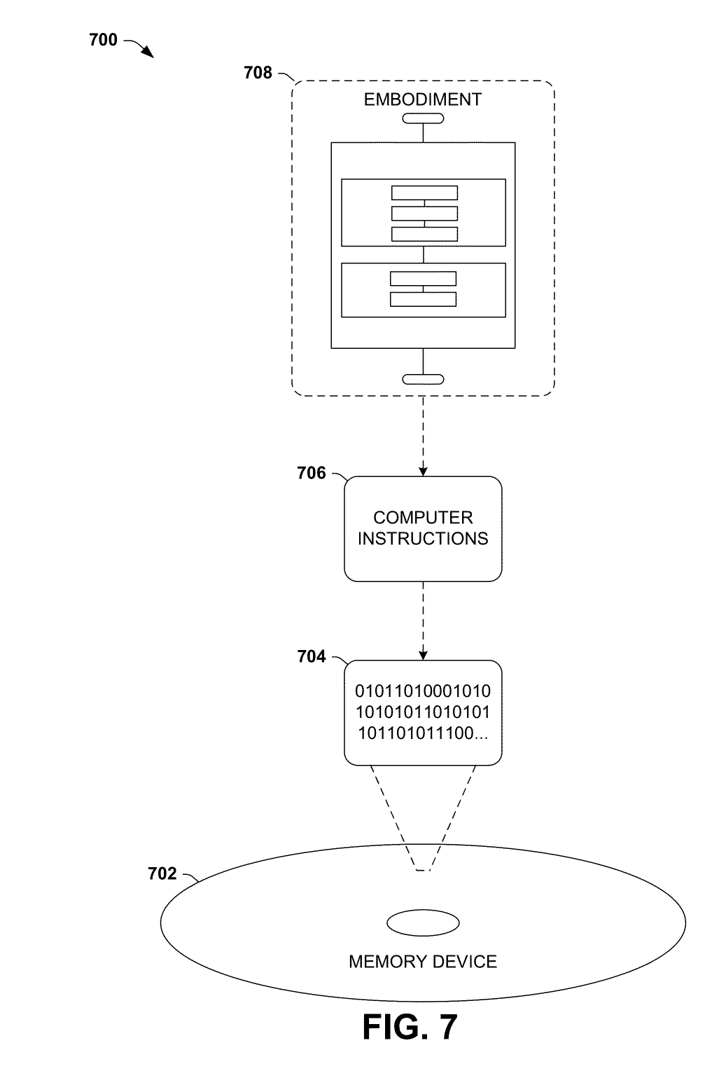

An exemplary computer-readable medium that may be devised in these ways is illustrated in FIG. 7, wherein the implementation 700 comprises a memory device 702 (e.g., a CD-R, DVD-R, or a platter of a hard disk drive), upon which is encoded computer-readable data 704. This computer-readable data 704 in turn comprises a set of computer instructions 706 that are configured to operate according to the principles set forth herein. In a first such embodiment, the processor-executable instructions 706 may be configured to cause a device to verify a predicted orientation 200 of a lidar sensor 112, such as the exemplary method 500 of FIG. 5. In a second such embodiment, the processor-executable instructions 706 may be configured to implement one or more components of a system for calibrating a lidar sensor 112, such as the exemplary system 606 in the exemplary device 602 of FIG. 6. Many such memory devices may be devised by those of ordinary skill in the art that are configured to operate in accordance with the techniques presented herein.

### E. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary method 500 of FIG. 5; the exemplary system 606 of FIG. 6; and the exemplary memory device 702 of FIG. 7) to confer individual and/or synergistic advantages upon such embodiments.

E1. Scenarios

A first aspect that may vary among embodiments of these techniques relates to the scenarios wherein such techniques may be utilized.

As a first variation of this first aspect, the techniques presented herein may be utilized in a variety of lidar-equipped devices, such as laptops, tablets, phones and other communication devices, cameras, headsets, earpieces, eyewear, wristwatches, portable gaming devices, portable media players such as televisions and music players, mobile navigation devices, mobile appliances, and vehicles. Such devices may also use a variety of lidar scanning techniques, such as variations in the wavelength and/or frequency of the light projected and/or detected by the lidar sensor 112.

As a second variation of this first aspect, the techniques presented herein may be utilized in a variety of lidar scanning scenarios. As a first such scenario, a vehicle 110 may travel through an environment 102 while utilizing a lidar sensor 112 to map the objects in the environment 102, such as a pedestrian walking through an area; a bicycle or automobile driving through an area; or an aircraft flying over an area. As a second such scenario, a vehicle 110 may utilize a lidar sensor 112 to detect the existence, locations, sizes, shapes, orientations, surface features, and/or velocities of other vehicles 104, such as in lidar-assisted vehicle navigation. As a third such scenario, a wearable device, such as a headset, may utilize a lidar sensor 112 to detect the orientation of the wearable device, such as the orientation of the gaze of the user, and/or the presence of other users and devices in the proximity of the user. As a fourth such scenario, an object scanner may utilize a lidar sensor to scan the contours of a three-dimensional object positioned within a scanning chamber.

As a third variation of this first aspect, many types of orientation calibration may be achieved through the use of the techniques presented herein. Such orientation may include, e.g., pitch, heading or yaw, roll, displacement, linearity, location, and/or velocity of the lidar sensor 112, or a combination thereof, with respect to a stationary frame of reference and/or with respect to a vehicle 110 or user operating the lidar sensor 112.

As a fourth variation of this first aspect, the orientation calibration may be performed under a variety of circumstances involving lidar scanning. As a first such example, the orientation calibration may be performed prior to deploying the lidar sensor 112 to an environment 102; e.g., a test surface may be provided in a garage for a lidar-equipped vehicle 110, such that the orientation of the lidar sensor 112 may be verified just before initiating vehicular lidar-based area mapping. As a second such example, the orientation calibration may be performed during deployment of the lidar sensor 112 to an environment 102, e.g., to verify the predicted orientation 200 of the lidar sensor 112 continuously or periodically during use. As a third such example, the orientation calibration may be triggered by an event, e.g., upon detecting the proximity of a surface 302 whereupon the lidar pattern 304 may be projected and detected, or upon detecting an event that may alter the orientation of the lidar sensor 112, such as a physical impact. As a fourth such example, the orientation calibration may be triggered when an evaluation of lidar data captured by the lidar sensor 112 indicates a potential miscalibration. As a fifth such example, the orientation calibration may be performed after lidar-based scanning, e.g., when a vehicle 110 has returned to the garage following a lidar-based area scanning session, and/or in conjunction with analyzing lidar data captured during a previous scanning session. Additionally, various portions of the techniques presented herein may be performed at different times; e.g., the projection and detection of the lidar pattern 304 may be initiated while the lidar sensor 112 is deployed within an environment 102, and the detected angles 312 may be compared with the predicted angles 310 during a subsequent data analysis phase. Those of ordinary skill in the art may devise many such scenarios wherein the techniques presented herein may be advantageously utilized.

E2. Lidar Pattern Projection and Detection

A second aspect that may vary among embodiments of the techniques presented herein involves the projection and/or detection of a lidar pattern 304 on a surface 302.

As a first variation of this second aspect, many types of surfaces 302 may be utilized in the calibration techniques provided herein, such as the façade of a building; a street sign; a side of another vehicle; a bridge or underpass; natural features, such as cliffs or embankments; and/or the ground below the vehicle. Additionally, many types of patterns 304 may be projected against such surfaces 302, including lines, rectangles, circles, and various other geometric and/or lexicographic symbols.

As a second variation of this second aspect, the lidar calibration may be performed to evaluate the orientation of the lidar sensor 112 along a selected dimension or axis, and a suitable lidar pattern 304 and/or surface 302 may be selected to this end. As a first such example, the orientation calibration may be performed upon detecting a surface 302 proximate to the location 300 of the lidar sensor 112 that is approximately orthogonal to the selected dimension. For example, an orientation calibration is to be evaluated for the vertical pitch of the lidar sensor 112 may be performed by detecting a surface 302 that is approximately vertically orthogonal with the lidar sensor 112, such that a lidar pattern 304 such as a vertical line may be projected thereupon to detect the vertical calibration of the lidar sensor 112, even if the surface 302 is not necessarily horizontally orthogonal with the lidar sensor 112. An embodiment of the calibration techniques provided herein may therefore determine the predicted angle 310 of the lidar sensor 112 at the location 330 according to the predicted orientation 200 and specifically along the selected dimension; may determine the detected angle 306 of the lidar pattern 304 specifically along the selected dimension; and may compare the detected angle 306 and the predicted angle 310 to determine the orientation difference 316 along the selected dimension. In this manner, the calibration technique may be isolated to a one-dimensional axis, which may be faster, more accurate, more efficient, and/or more suitable for a particular scenario than a multi-axis calibration technique.

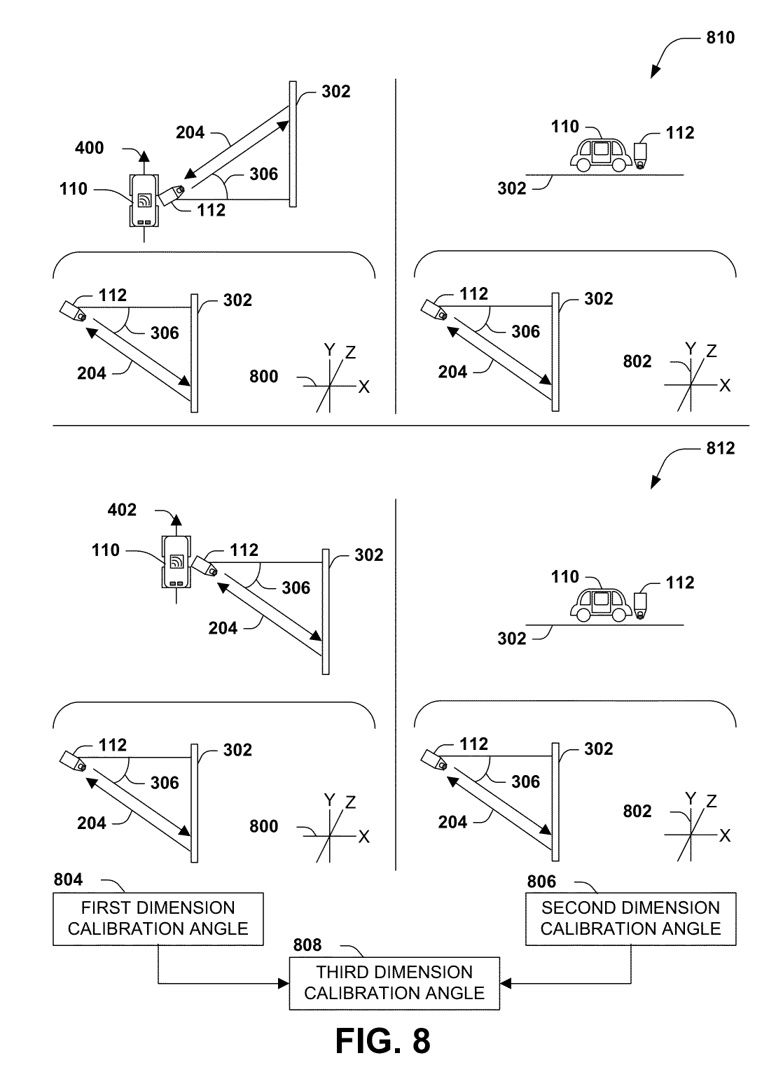

FIG. 8 presents an illustration of an exemplary scenario featuring a third variation of this second aspect, wherein the orientation calibration is performed in a one-dimensional manner, but is performed concurrently in two dimensions in order to provide a multi-dimensional evaluation. In this exemplary scenario, at a first time 810 and/or a first location 400, a vehicle 110 operates a lidar sensor 112 to project a first lidar pattern 304 on a first surface 302, such as a façade of a building, in order to determine a first detected angle 306 along a first dimension 800, such as a horizontal axis. The vehicle 110 also utilizes a lidar sensor 112 (e.g., using the same lidar sensor 112 by consecutively orienting it at each surface 302, and/or concurrently using a second lidar sensor 112) to project a second lidar pattern 304 at a second surface 302 along a second dimension 802, such as the ground, in order to detect a second detected angle 306 of the lidar sensor 112 with the second surface 302. The first detected angle 306 may be compared with a first predicted angle 310 of a first predicted orientation 200 along the first dimension 800, and the second detected angle 306 may be compared with a second predicted angle 310 of a second predicted orientation 200 along the second dimension 802. At a second time 812 and from a second location 402, the vehicle 110 may detect the detected angles 306 of the respective dimensions, and may therefore determine a first dimension calibration angle 804 along the first dimension 800 (e.g., an orientation difference 316 of the lidar sensor 112 along the horizontal axis) and a second dimension calibration angle 806 along the second dimension 802 (e.g., an orientation difference 316 of the lidar sensor 112 along the vertical axis). Moreover, from the first orientation difference 316 and the second orientation difference 316, an embodiment may determine a third orientation difference of the lidar sensor 112 along a third dimension. For example, by detecting the orientation difference 316 of the lidar sensor 112 along the first dimension and the second dimension, an embodiment may detect the orientation difference 316 of the lidar sensor 112 in the third dimension.

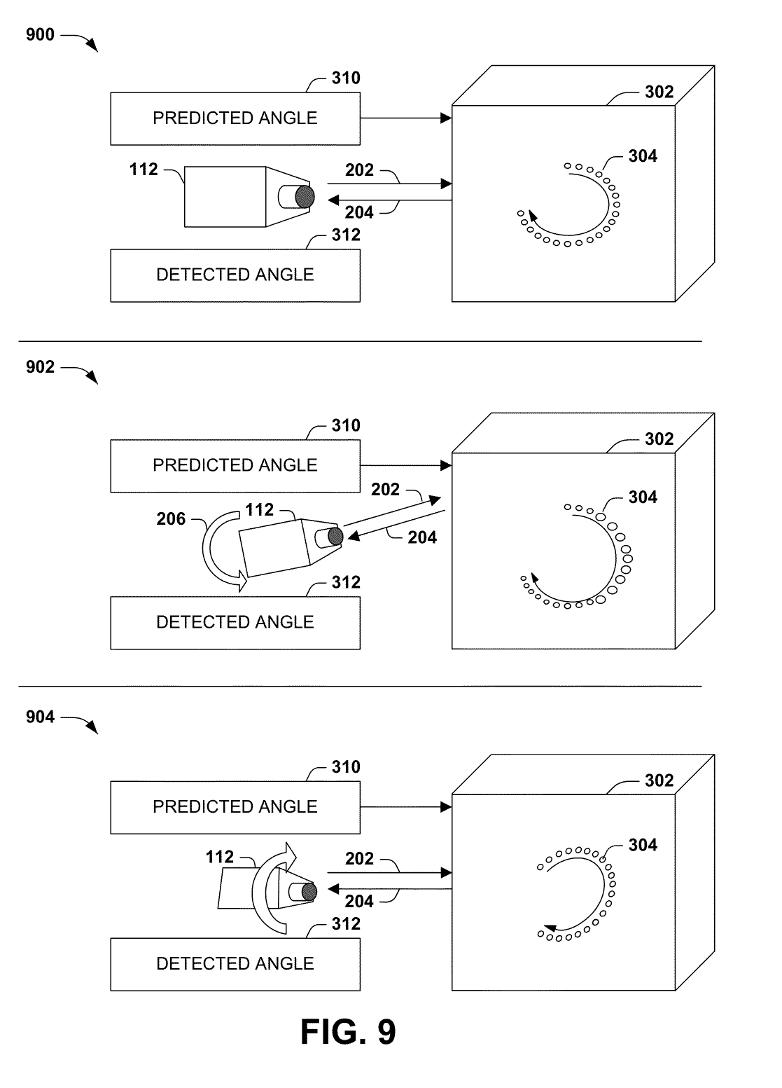

FIG. 9 presents an illustration of exemplary scenarios featuring a fourth variation of this second aspect, wherein the projection of a multi-dimensional lidar pattern 304 on an orthogonal surface 302 enables the concurrent detection of the orientation of the lidar sensor 112 in multiple dimensions. In these exemplary scenarios, the lidar pattern 304 is an arc projected along two dimensions, such that the lidar sensor 112 may evaluate the detection of the lidar pattern 304 on the surface 302 to determine the orientation along multiple dimensions. In a first exemplary scenario 900, in a correctly calibrated orientation, the lidar pattern 304 projected on an orthogonal surface 302 is detected by the lidar sensor 112 as having detected angles 312 that match predicted angles 310. In a second exemplary scenario 902, where the lidar sensor 112 exhibits orientation miscalibration in the form of an incorrect heading rotation 206, the lidar sensor 112 may determine from the detection of the projected lidar pattern 304 that one side of the lidar pattern 304 appears to be closer to the lidar sensor 112 than the other side. If the orientation of the surface 302 is verified as orthogonal to the lidar sensor 112, and/or if this discrepancy is consistently observed from a variety of locations 300 and/or with a variety of surfaces 302, the lidar sensor 112 may be presumed to exhibit an incorrect heading rotation 206, and the magnitude of the miscalibration may be evaluated based on the magnitude of the discrepancy. In a third exemplary scenario 904, an orientation miscalibration of the lidar sensor 112 in the form of a roll rotation 206 may be detected according to the alignment of the lidar pattern 304 projected on the surface 302. In this manner, the projection and detection of various lidar patterns 304 may enable a multi-dimensional determination the orientation calibration of the lidar sensor 112 in accordance with the techniques presented herein.

E3. Orientation Difference Determination

A third aspect that may vary among embodiments of these techniques involves the determination of the orientation difference 316 of the predicted orientation 200 and the detected angles 306 of the lidar sensor 112.

As a first variation of this third aspect, for the respective lidar responses comprising the lidar pattern 304, an embodiment of the techniques presented herein may calculate a relative coordinate of the lidar response, and translate the relative coordinate of the lidar response to a registered coordinate within a registered coordinate system. For example, an embodiment may detect lidar points and/or point clouds 118 using the lidar sensor 112, and then perform a registration 120 of such points and/or point clouds 118 into voxels 120 represented in a three-dimensional coordinate system 124.

As a second variation of this third aspect, when the lidar sensor 112 is provided in a context involving movement at a velocity, such as mounting in a moving vehicle 104, the orientation calibration may involve translating the relative coordinates of the lidar pattern 304 to registered coordinate within the registered coordinate system and also according to the velocity of the lidar sensor 112. As a first such example, when the lidar points of the lidar pattern 304 are detected while the lidar sensor 112 is moving relative to the surface 302, the orientation calibration may offset the respective voxels 124 according to the location 300 of the vehicle 110 at each respective time in order to register the respective voxels 124 in a stationary coordinate set 124. Alternatively, the orientation calibration may be performed upon detecting an opportunity when the vehicle 110 is stationary at a location 300 near a surface 302.

As a third variation of this third aspect, the detected angle 306 of the projection of the lidar pattern 304 on the surface 302, with respect to the location 300 of the lidar sensor 112 and the surface 302, may be determined in a variety of ways. For example, instances of detected angles 306 may be determined for the projection of the lidar pattern 304 on the surface 302 from at least two locations 300, and the detected angle 306 to be compared with the predicted angle 310 may be determined by a comparison of the respective instances of the detected angles 306, such as in the exemplary scenarios of FIG. 4. Alternatively or additionally, instances of detected angles 306 may be determined for at least two lidar responses of the lidar pattern 304, and the detected angle 306 to be compared with the predicted angle 310 may be determined by a comparison of the respective instances of the detected angles 306 for respective lidar responses of the lidar pattern 304, such as in the exemplary scenarios of FIG. 9. As a still further alternative or additional variation, multiple instances of the same lidar pattern 304 or various lidar patterns 304 may be projected on the surface 302 from the same location 300, and the detected angle 306 may be detected as an aggregation of the various lidar patterns 304, such as a statistical mean. Alternatively or additionally, aggregation may enable further evaluation of the detected angle 312; e.g., the standard deviation of the detected angle 312 may enable a measure of the confidence in the detected angle 312 of the lidar sensor 112, and the comparison with the predicted angle 310 may be performed when the standard deviation of the detected angle 312 is within an acceptable confidence range for a statistically significant sample size. Aggregation may also be utilized to determine the orientation difference 316 with respect to a predicted orientation 200; e.g., for respective lidar responses for the lidar pattern 304, an orientation difference 316 of the lidar response from the corresponding predicted angle 310 may be detected, and an aggregated difference between the detected angles 306 of the respective lidar responses and the corresponding predicted angles 310 may be determined. Those of ordinary skill in the art may devise many ways of determining the orientation difference 316 of the lidar sensor 112 while implementing the techniques presented herein.

E4. Uses of Orientation Difference

A fourth aspect that may vary among embodiments of the techniques presented herein involves the use of a determination of an orientation difference 316 between the predicted orientation 200 and the detected angles 312.

As a first variation of this fourth aspect, the techniques presented herein may be utilized to achieve an initial calibration of the lidar sensor 112 when no predicted orientation 200 has yet been devised. In this context, the projection of a lidar pattern 304 on a surface 302, and the detection of the orientation difference 316 based on the detected angles 312, may provide an initial indication of the current orientation of the lidar sensor 112 along one or more dimensions.

As a second variation of this fourth aspect, the techniques presented herein may be utilized to detect divergence of the lidar sensor 112 from a presumed correct orientation. Upon determining a nonzero orientation difference 316 between the detected angle 312 and the predicted angle 310 when the lidar sensor 112 is in the correct orientation, an embodiment may alter the predicted orientation 200 from the correct orientation in view of the detected angle 312. Such altering may comprise simply setting the predicted orientation 200 to a presumed orientation based on the detected angles 312, or incrementally altering the predicted orientation 200 toward the detected angles 312 (e.g., proportional to a magnitude of the orientation difference). An incremental adjustment may average the predicted orientation 200 over several sets of detected angles 312 using lidar patterns 304 projected on a variety of surfaces 302.

As a third variation of this fourth aspect, the lidar sensor 112 may be adjusted according to the predicted orientation 200 and the orientation difference 316. For example, the lidar sensor 112 may be affixed in a mount featuring motors that may be activated to physically reorient the calibration of the lidar sensor 112 according to the orientation difference. A detection of an orientation difference 316 along a particular dimension (e.g., a pitch rotation) may be corrected by activating a motor that precisely reorients the pitch of the lidar sensor 112 to counteract the orientation difference 316.

As a fourth variation of this fourth aspect, when an orientation difference 316 is detected, a user may be notified of the miscalibration of the lidar sensor 112. The user may be advised to suspend a lidar scanning session until the orientation of the lidar sensor 112 is recalibrated. Alternatively, the user may be advised of adjustments that may correct the miscalibration of the lidar sensor 112, e.g., that altering the pitch of the lidar sensor 112 by a tenth of a degree may resolve the orientation difference 316.

As a fifth variation of this fourth aspect, an orientation difference 316 may be used in conjunction with the data captured by the lidar sensor 112. For example, if the lidar sensor 112 is determined to have a heading miscalibration of 0.1 degrees, the heading of the data recorded by the lidar sensor may be adjusted to reflect the heading miscalibration (e.g., projecting the lidar points into the three-dimensional coordinate system 122). Alternatively or additionally, the data captured by the lidar scanner 112 may subsequently be evaluated in view of a recorded orientation difference 316; e.g., post-processing of the lidar scanning data may be adjusted to account for the miscalibration of the lidar sensor 112 during the scanning session. Those of ordinary skill in the art may devise many such uses for the detection of an orientation difference 316 of the lidar scanner 112 from the predicted orientation 200 determined in accordance with the techniques presented herein.

### F. Computing Environment

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments to confer individual and/or synergistic advantages upon such embodiments.

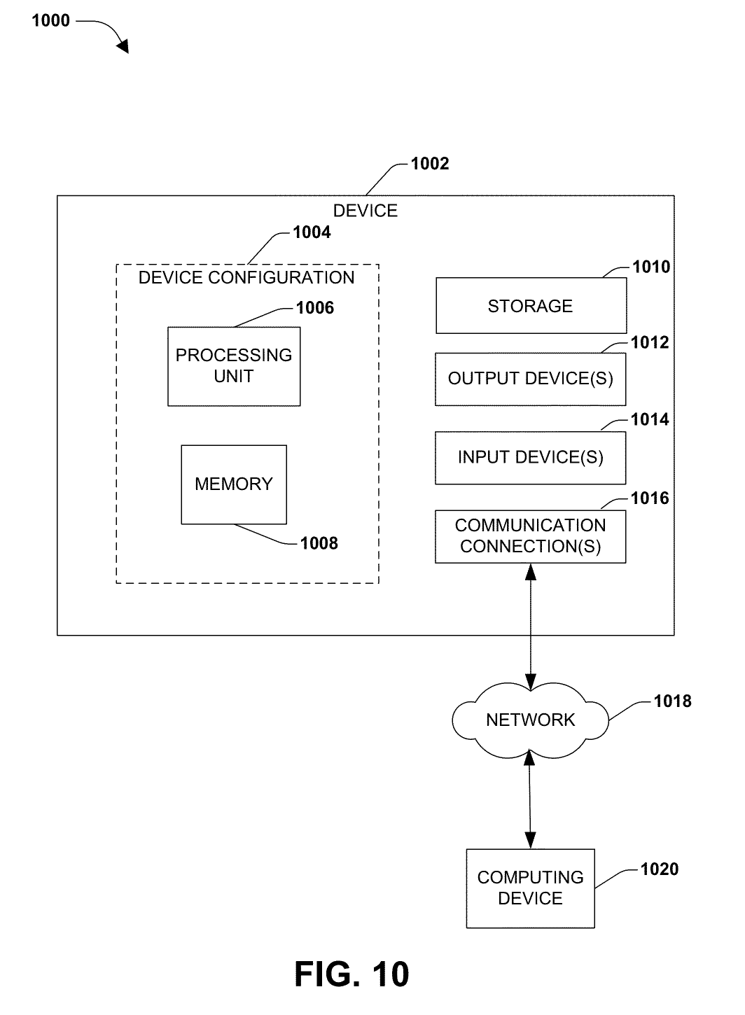

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1000 comprising a computing device 1002 configured to implement one or more embodiments provided herein. In one configuration, computing device 1002 includes at least one processing unit 1006 and memory 1008. Depending on the exact configuration and type of computing device, memory 1008 may be volatile (such as RAM, for example), non-volatile (such as ROM, flash memory, etc., for example) or some combination of the two. This configuration is illustrated in FIG. 10 by dashed line 1004.

In other embodiments, device 1002 may include additional features and/or functionality. For example, device 1002 may also include additional storage (e.g., removable and/or non-removable) including, but not limited to, magnetic storage, optical storage, and the like. Such additional storage is illustrated in FIG. 10 by storage 1010. In one embodiment, computer readable instructions to implement one or more embodiments provided herein may be in storage 1010. Storage 1010 may also store other computer readable instructions to implement an operating system, an application program, and the like. Computer readable instructions may be loaded in memory 1008 for execution by processing unit 1006, for example.

The term “computer readable media” as used herein includes computer storage media. Computer storage media includes volatile and nonvolatile, removable and non-removable media implemented in any method or technology for storage of information such as computer readable instructions or other data. Memory 1008 and storage 1010 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1002. Any such computer storage media may be part of device 1002.

Device 1002 may also include communication connection(s) 1016 that allows device 1002 to communicate with other devices. Communication connection(s) 1016 may include, but is not limited to, a modem, a Network Interface Card (NIC), an integrated network interface, a radio frequency transmitter/receiver, an infrared port, a USB connection, or other interfaces for connecting computing device 1002 to other computing devices. Communication connection(s) 1016 may include a wired connection or a wireless connection. Communication connection(s) 1016 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1002 may include input device(s) 1014 such as keyboard, mouse, pen, voice input device, touch input device, infrared cameras, video input devices, and/or any other input device. Output device(s) 1012 such as one or more displays, speakers, printers, and/or any other output device may also be included in device 1002. Input device(s) 1014 and output device(s) 1012 may be connected to device 1002 via a wired connection, wireless connection, or any combination thereof. In one embodiment, an input device or an output device from another computing device may be used as input device(s) 1014 or output device(s) 1012 for computing device 1002.

Components of computing device 1002 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 1002 may be interconnected by a network. For example, memory 1008 may be comprised of multiple physical memory units located in different physical locations interconnected by a network.

Those skilled in the art will realize that storage devices utilized to store computer readable instructions may be distributed across a network. For example, a computing device 1020 accessible via network 1018 may store computer readable instructions to implement one or more embodiments provided herein. Computing device 1002 may access computing device 1020 and download a part or all of the computer readable instructions for execution. Alternatively, computing device 1002 may download pieces of the computer readable instructions, as needed, or some instructions may be executed at computing device 1002 and some at computing device 1020.

### G. Use of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of verifying a predicted orientation of a lidar sensor positioned at a location near a surface, the method comprising:
from the location, projecting a lidar pattern on the surface;
upon detecting the lidar pattern with the lidar sensor, determining a detected angle of the lidar pattern;
determining a predicted angle of the lidar sensor at the location with the predicted orientation; and
comparing the detected angle of the lidar pattern with the predicted angle to determine an orientation difference.

2. The method of claim 1, wherein the surface is approximately orthogonal to the lidar sensor.

3. The method of claim 2, wherein:
the surface is approximately orthogonal to the lidar sensor in a selected dimension; and
determining the predicted angle further comprises: determining the predicted angle of the lidar sensor at the location with the predicted orientation along the selected dimension;
determining the detected angle further comprises: determining the detected angle of the lidar pattern along the selected dimension; and
determining the orientation difference further comprises: comparing the detected angle of the lidar pattern with the predicted angle to determine the orientation difference along the selected dimension.

4. The method of claim 3, wherein:
the lidar sensor has a second predicted orientation along a second dimension; and
the method further comprises:
determining a second predicted angle of the lidar sensor at the location with the predicted orientation along the second dimension;
determining a second detected angle of the second lidar pattern along the second dimension; and
determining a second orientation difference along a second dimension by comparing a second detected angle of the lidar pattern along the second dimension with the second predicted angle along the second dimension.

5. The method of claim 4, wherein:
the surface is approximately orthogonal to the lidar sensor in the selected dimension and the second dimension; and
determining the orientation difference further comprises:
for the selected dimension, determine a first orientation difference along the first dimension by comparing a first detected angle of the lidar pattern along the first dimension of the surface with a first predicted angle along the first dimension; and
for the second dimension, determine a second orientation difference along the second dimension by comparing a second detected angle of the lidar pattern of the surface along the second dimension with the second predicted angle along the second dimension.

6. The method of claim 4, wherein:
a second surface near the location is approximately orthogonal to the lidar sensor in the second dimension; and
the method further comprises:
from the location, projecting a second lidar pattern on the second surface;
upon detecting the second lidar pattern with the lidar sensor, determining the second detected angle of the second lidar pattern along the second dimension; and
comparing the second detected angle of the second lidar pattern with the second predicted angle to determine the second orientation difference along the second dimension.

7. The method of claim 4, wherein:
the lidar sensor has a third predicted orientation along a third dimension; and
the method further comprising: from the first orientation difference and the second orientation difference, determine a third orientation difference of the lidar sensor along the third dimension.

8. A system for calibrating a lidar sensor positioned at a location near a surface and having a predicted orientation, the system comprising:
a lidar pattern projector that, from the location, projects a lidar pattern on the surface;
a lidar pattern detector that:
detects the lidar pattern with the lidar sensor, and
determines a detected angle of the lidar pattern;
a prediction determiner that determines a predicted angle of the lidar sensor at the location with the predicted orientation; and
a lidar calibrator that:
compares the detected angle of the lidar pattern with the predicted angle to determine an orientation difference; and
calibrates the lidar sensor according to the orientation difference.

9. The system of claim 8, wherein detecting the lidar pattern with the lidar sensor further comprises, for respective lidar responses detected by the lidar sensor:
calculating a relative coordinate of the lidar response; and
translating the relative coordinate of the lidar response to a registered coordinate within a registered coordinate system.

10. The system of claim 9, wherein:
the lidar sensor is moving at a velocity; and
translating the relative coordinate further comprises: translating the relative coordinate of the lidar response to the registered coordinate within the registered coordinate system and according to the velocity of the lidar sensor.

11. The system of claim 9, wherein projecting the lidar pattern further comprises: while the lidar sensor is stationary at the location, projecting a lidar pattern on the surface.

12. The system of claim 8, wherein:
detecting the lidar pattern with the lidar sensor further comprises: detecting at least two lidar responses of the lidar pattern;
determining the detected angle of the lidar pattern further comprises: for the respective at least two lidar responses, determining the detected angle of the lidar response; and
determining the orientation difference further comprises: determining an aggregated difference of the detected angle of the respective at least two lidar responses and a corresponding predicted angle for the lidar response.

13. The system of claim 12, wherein the aggregated difference comprises an aggregated difference of the respective detected angles of the lidar responses and corresponding predicted angles for the lidar responses.

14. A memory device storing instructions that, when executed on a processor of a lidar sensor, cause the lidar sensor to verify a predicted orientation of the lidar sensor positioned at a location near a surface, by:
from the location, projecting a lidar pattern on the surface;
upon detecting the lidar pattern with the lidar sensor, determining a detected angle of the lidar pattern;
determining a predicted angle of the lidar sensor at the location with the predicted orientation; and
comparing the detected angle of the lidar pattern with the predicted angle to determine an orientation difference.

15. The memory device of claim 14, wherein:
the predicted orientation of the lidar sensor comprises a correct orientation of the lidar sensor; and
the instructions further cause the lidar sensor to, upon determining a nonzero orientation difference between the detected angle and the predicted angle, alter the predicted orientation from the correct orientation in view of the detected angle.

16. The memory device of claim 15, wherein the instructions further cause the lidar sensor to adjust the predicted orientation toward the detected angle.

17. The memory sensor of claim 16, wherein adjusting the predicted orientation further comprises: adjusting the predicted orientation toward the detected angle proportional to a magnitude of the orientation difference.

18. The memory device of claim 14, wherein:
the lidar sensor further detects at least one lidar input; and
the instructions further cause the lidar sensor to adjust the lidar input according to the predicted orientation and the orientation difference of the lidar sensor.

19. The memory device of claim 14, wherein the instructions further cause the lidar sensor to physically reorient the lidar sensor according to the orientation difference.

20. The memory device of claim 14, wherein the instructions further cause the lidar sensor to advise a user of the lidar sensor to reorient the lidar sensor according to the orientation difference.
